(19) United States
(12) Patent Application Publication
(10) Pub. No.: US 2024/0313363 A1
(43) Pub. Date: Sep. 19, 2024

(54) ARTICLE AND SYSTEM FOR A JOINING PROCESS AND METHOD OF USING THE SAME

(71) Applicant: KJ Engineering Design, LLC, Fremont, OH (US)

(72) Inventors: Kyle Wasserman, Fremont, OH (US); Kyle Keiser, Holland, OH (US)

(21) Appl. No.: 18/609,737

(22) Filed: Mar. 19, 2024

Related U.S. Application Data
(60) Provisional application No. 63/491,075, filed on Mar. 19, 2023.

(51) Int. Cl. H01M 50/516; B23K 26/03; B23K 26/21

(52) U.S. Cl. CPC H01M 50/516; B23K 26/032; B23K 26/21

(57) ABSTRACT

An article, system, and joining process for a battery assembly. The article comprises a main body having a center bore formed therein. The system is configured to use the article in the joining process to bond together workpieces of the battery assembly. Each of the article, system, and joining process can be readily introduced into existing production and/or assembly lines with only minimum revisions to, and interruption of, such lines, and bonds together workpieces of the battery assembly with a high level of quality and repeatability, yet at reduced manufacturing costs.

### CROSS-REFERENCE TO RELATED APPLICATION

This application claims the benefit of U.S. Provisional Patent Application Ser. No. 63/491,075, filed Mar. 19, 2023, the entirety of which is herein incorporated by reference.

### FIELD

The disclosure relates to a joining process, and more particularly an article and system for a joining process and method of using the same.

### BACKGROUND

Conventional joining processes such as welding, brazing, bonding, riveting, clinching, and fastening, use different forms of energy to join workpieces that were previously separated. Welding, in particular, is a permanent joining process that joins workpieces produced from materials, usually metals or thermoplastics, by using high heat to melt the parts together and allowing them to cool, causing fusion. Oftentimes, an additional material, also known as a filler material, is added during the heating process to help bond the two workpieces together.

Various types of welding process are known and used. One such type of welding process is fusion welding. Different types of fusion welding processes use various means to produce heat. For example, an arc welding process employs an electric arc, a laser beam welding process uses a focused laser beam, a high-energy welding process uses light radiation, and an electronic beam welding process involves high-velocity electrons. Heat produced by the fusion welding process melts materials of the workpieces and/or filler material and allows them to mix together. Once the heat is removed, the materials begin to cool and solidify, and fuse the workpieces together. Such joining process is able to automatically form, on a continuous, reproducible, high speed, production-line basis, bonds devoid of structural, electrical, and/or cosmetic defects between the workpieces.

Battery manufacturing is growing exponentially, driven by technological advances across many industries. There is not only an increased demand for supply, however. Industries are requiring high performance and efficiency in battery packages that are ever more compact, in configuration that are challenging to design and construct. Reliability and safety are also key factors in modern battery design. For manufacturers, there is also pressure of maintaining development and production schedules while also providing a cost effective, quality product.

Accordingly, it is desirable to develop an improved joining process which can be readily introduced into existing production and/or assembly lines with only minimum revisions to, and interruption of, such lines, and is capable of bonding workpieces with a high level of quality and repeatability, yet at reduced manufacturing costs.

### SUMMARY

In concordance and agreement with the presently described subject matter, an improved joining process which can be readily introduced into existing production and/or assembly lines with only minimum revisions to, and interruption of, such lines, and is capable of bonding workpieces with a high level of quality and repeatability, yet at reduced manufacturing costs, has been newly designed.

In one embodiment, an article used in a joining process for a battery assembly, comprises: a main body configured to be cooperate with a connector for a battery assembly; and a bore formed in the main body, wherein the bore permits exposure of at least one joining surface of the battery assembly to a thermal energy source.

As aspects of some embodiments, the main body includes generally planar opposing axial surfaces and a substantially smooth peripheral surface.

As aspects of some embodiments, the bore is formed through an entirety of the main body.

As aspects of some embodiments, the main body is one of a solid disk shape and a ring shape.

As aspects of some embodiments, the article is produced from at least one of a lead material and a lead alloy material.

In another embodiment, a system for a battery cell joining process, comprises: a joining machine including a thermal energy source, wherein joining machine uses at least one article to couple together a plurality of battery cells to form a battery assembly, wherein the at least one article comprises a main body configured to permit exposure of at least one joining surface of at least one of the battery cells to the thermal energy source.

As aspects of some embodiments, the at least one article is disposed in at least one opening of a connector of the battery assembly.

As aspects of some embodiments, the system further comprises a controller in communication with the joining machine, wherein the controller is configured to control an operation of the joining machine.

As aspects of some embodiments, the system further comprises a vision system, wherein the vision system captures at least one image of the at least one joining surface of the battery cell.

As aspects of some embodiments, the vision system is in communication with the controller to define an exact location of positive and negative electrode terminals of the battery cells.

In yet another embodiment, a joining process, comprises: providing a joining system including a joining machine configured to use one or more articles to couple together a plurality of workpieces; loading the workpieces into the joining system; disposing the one or more articles on the workpieces; and coupling the workpieces together by causing the one or more articles and a portion of the workpieces to be integrally joined.

As aspects of some embodiments, the workpieces are battery cells.

As aspects of some embodiments, the joining process further comprises disposing at least one connector on adjacent workpieces prior to disposing the one or more articles on the workpieces.

As aspects of some embodiments, the joining process further comprises disposing at least one retainer on the at least one connector to militate against leakage of a molten material.

As aspects of some embodiments, the joining process further comprises causing a first pass of a thermal energy source to cause a portion of the workpieces and the at least one connector to be integrally joined.

As aspects of some embodiments, wherein the step of disposing the one or more articles on the workpieces occurs after the first pass of the thermal energy source.

As aspects of some embodiments, wherein the step of coupling the workpieces together by causing the one or more articles and a portion of the workpieces to be integrally joined is achieved during a second pass of the thermal energy source.

As aspects of some embodiments, wherein the joining system further includes a vision system to locate a position of at least one of the workpieces, the at least one connector, and the at least one article.

As aspects of some embodiments, wherein the vision system captures one or more images to locate joining surfaces of the workpieces.

As aspects of some embodiments, wherein the joining system further includes a controller in communication with the joining machine, wherein the joining machine, via the controller, moves a depth laser above one or more locations of the connectors to measure and/or define a depth of joining surfaces of the workpieces.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a mold fixture and an associated article for a joining process according to an embodiment of the presently disclosed subject matter, wherein the mold includes a movable member in a fully retracted first position to form a solid disk-shaped article;

FIG. 2 is a top perspective view of the mold fixture of FIG. 1 and an associated article for a joining process according to an embodiment of the presently disclosed subject matter, wherein the movable member is in a fully extended second position to form a ring-shaped article;

FIGS. 3-4 are top plan views illustrating exemplary workstations including a joining system configured to use the articles of FIGS. 1 and 2 according to an embodiment of the presently disclose subject matter;

FIG. 5A is a schematic sectional view of a plurality of workpieces to be joined using the articles of FIGS. 1 and 2 according to an embodiment of the presently disclosed subject matter, wherein the workpieces and a connector are shown prior to completion of a first pass of a thermal energy source (i.e., burn or weld);

FIG. 5B is a schematic sectional view of the workpieces of FIG. 5A after the first pass of the thermal energy source is completed;

FIG. 5C is a schematic sectional view of the workpieces of FIGS. 5A and 5B with the articles of FIG. 2 disposed thereon; and

FIG. 5D is a schematic sectional view of the workpieces of FIGS. 5A-5C after a second pass of the thermal energy source (i.e., burn or weld) is completed;

FIG. 6A is a top plan view of a plurality of workpieces to be joined using the articles of FIGS. 1 and 2 according to an embodiment of the presently disclosed subject matter, wherein the workpieces, connector, and retainers are shown prior to a first pass of a thermal energy source (i.e., burn or weld);

FIG. 6B is a top plan view of the workpieces of FIG. 5A after the first pass of the thermal energy source is completed;

FIG. 6C is a top plan view of the workpieces of FIGS. 5A and 5B with the articles of FIG. 2 disposed thereon; and

FIG. 6D is a top plan view of the workpieces of FIGS. 5A-5C after a second pass of the thermal energy source (i.e., burn or weld) is completed;

FIG. 7 is a flow diagram illustrating a method of using the article of FIGS. 1-2 and the joining system of FIGS. 3-4 according to an embodiment of the presently disclosed subject matter; and

FIG. 8 is a flow diagram illustrating a method of using the article of FIGS. 1-2 and the joining system of FIGS. 3-4 according to another embodiment of the presently disclosed subject matter.

### DETAILED DESCRIPTION

The following description of technology is merely exemplary in nature of the subject matter, manufacture and use of one or more present disclosures, and is not intended to limit the scope, application, or uses of any specific present disclosure claimed in this application or in such other applications as may be filed claiming priority to this application, or patents issuing therefrom. Regarding methods disclosed, the order of the steps presented is exemplary in nature, and thus, the order of the steps may be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” may encompass both an orientation of above and below. The device may be otherwise oriented (rotated 90 degrees or at other orientations) and the spatially relative descriptors used herein interpreted accordingly.

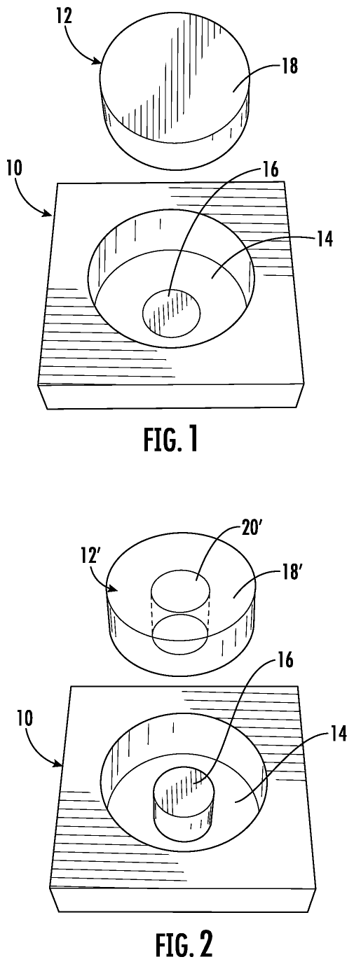

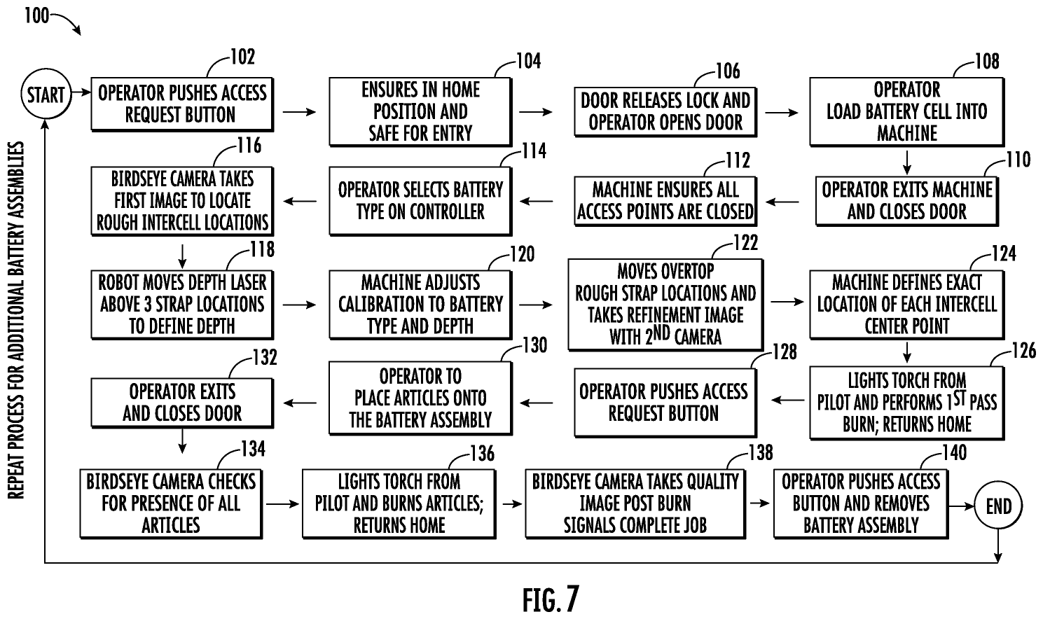

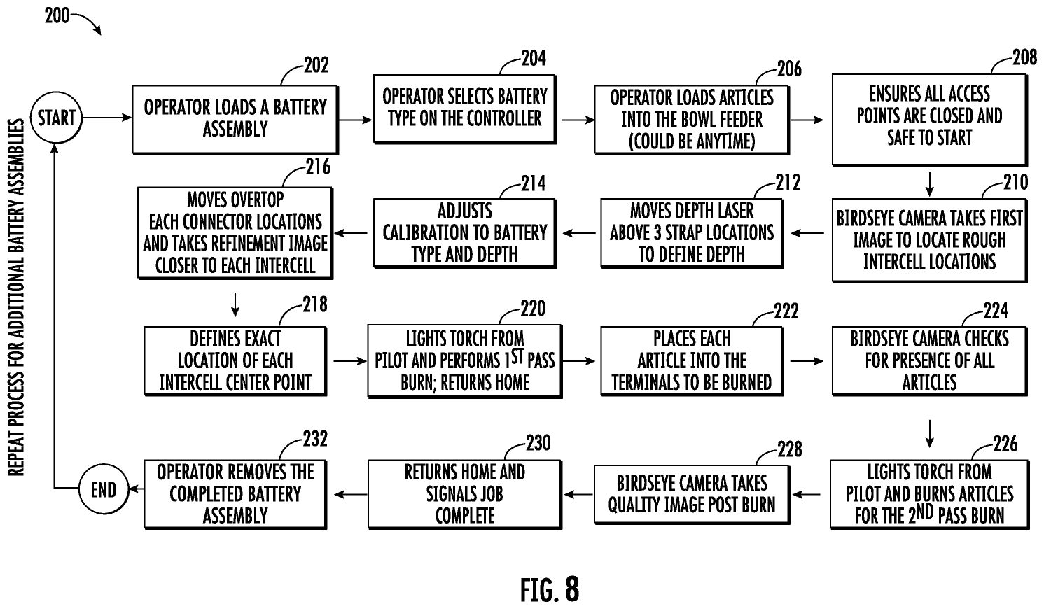

FIGS. 1 and 2 illustrate a mold fixture 10 and articles 12, 12′ produced therefrom for joining processes 100, 200 (depicted in FIGS. 7 and 8). It is understood that the articles 12, 12′ may be used with various other joining processes than the joining processes 100, 200 shown and described herein. The mold fixture 10 shown is a generally solid structure having a cavity 14 formed therein. The cavity 14 may have a shape, size, and configuration corresponding to the articles 12, 12′. In the embodiment shown, the cavity 14 has a generally disk shape to form a generally disk-shaped article 12. In certain instances, the mold fixture 10 may further include a movable member 16 for forming various embodiments of the articles 12, 12′. It is understood that the mold fixture 10 in the cavity 14 and the movable member 16 may include an amount of draft to improve release of the articles 12, 12′ from the mold fixture 10 and militate against damage to the articles 12, 12′ during an ejection therefrom. It is further understood that the mold fixture 10 may be made from any suitable material having a higher operating temperature than a melting point temperature of a material used for forming the articles 12, 12′. For example, the mold fixture 10 and/or movable member 16 may be made from a material comprising at least one of a steel, an aluminum, a brass, a bronze, a cast iron, or alloys thereof, and the articles 12, 12′ may be produced from a lead material or alloys thereof.

As illustrated, the movable member 16 may be disposed in the cavity 14 such that a longitudinal axis of the movable member 16 is in coaxial alignment with a central axis of the cavity 14. In some embodiments, the movable member 16 may be configured to be selectively positionable between a fully retracted first position, shown in FIG. 1, to form the article 12 with a solid disk-shaped main body 18, and a fully extended second position, shown in FIG. 2, to form the article 12′ with a ring-shaped main body 18′ having a bore 20′ formed therein. In some embodiments, the bore 20′ is formed as a center bore. It is understood, however, that the bore 20′ may be formed elsewhere in the main body 18′ as desired. The main body 18, 18′ may have generally planar opposing axial surfaces and a substantially smooth outer peripheral surface. It is understood that the articles 12, 12′ may have any shape, size, and configuration as desired. In some embodiments, the shape, size, and configuration of the articles 12, 12′ may depend on the application in which the articles 12, 12′ are used.

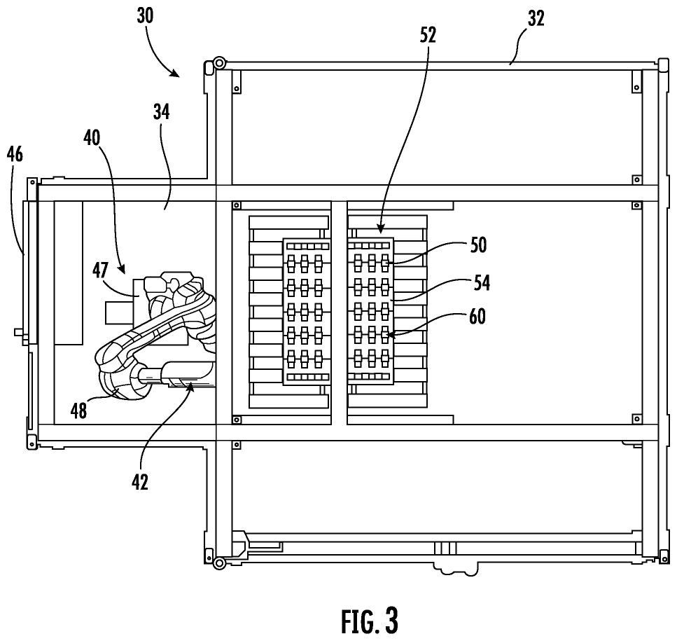

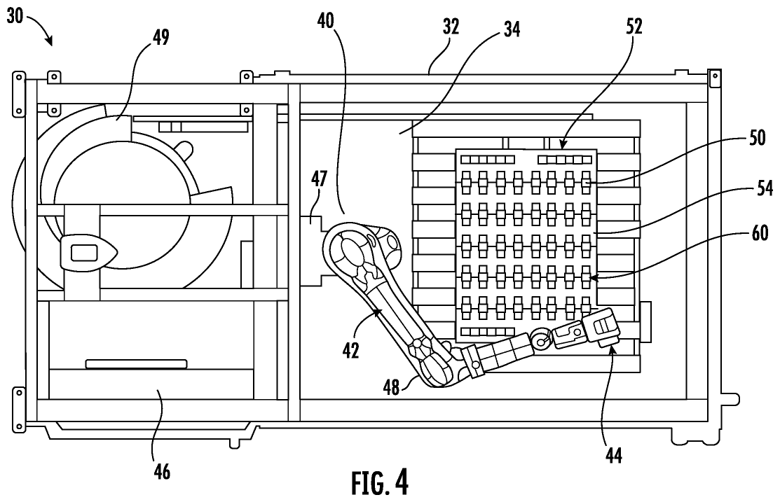

FIGS. 3-4 illustrate various workstations 30 for the joining processes 100, 200 that uses the articles 12, 12′ shown in FIGS. 1 and 2. As depicted, the joining processes 100, 200 may utilize a joining system 40 (e.g., a welding system) according to an embodiment of the present disclosure. It should be appreciated that the joining system 40 of the present disclosure may be incorporated and used with various other joining processes as desired. For example, the joining system 40 may be used in various other types of joining processes.

The workstation 30 may include an enclosure 32 to surround at least a portion of the joining system 40. The enclosure 32 may be a free-standing enclosure if desired. In some embodiments, the enclosure 32 may be configured to be fixedly secured to a mounting structure (e.g., a floor 34). The enclosure 32 may be configured to ensure safety to an operator and equipment as well as prevent objects and/or the operator from interfering during the joining processes 100, 200 and operation of the joining system 40. The enclosure 32 may also be ventilated to militate against exposure of the operator to undesirable and/or harmful fumes and particulates emitted during the joining processes 100, 200. An access door (e.g., a retractable door) and at least one wall panel of the enclosure 32 may be interlocked to further ensure the safety of the operator and the equipment as well as prevent objects and/or the operator from interfering during the joining process 100, 200 and the operation of the joining system 40. In another embodiment, the enclosure 32 may include an access opening provided with a non-mechanical barrier (e.g., a light curtain) to ensure the safety of the operator and the equipment as well as prevent objects and/or the operator from interfering during the joining process 100, 200 and the operation of the joining system 40. Main access to the workstation 30 by the operator and/or one or more workpieces 50 may be through the access door or the access opening of the enclosure 32. It is understood that the workstation 30 may employ various other mechanical and non-mechanical barriers to ensure safety to the operator and the equipment as well as prevent objects and/or the operator from interfering during the joining process 100, 200 and the operation of the joining system 40. In the event that the access door is not recognized as being interlocked with the at least one wall panel or the light curtain is interrupted, the joining system 40 may be configured to immediately cease operations until the access door is properly closed or the light curtain is restored. Depending on where in the joining process 100, 200 the operations are ceased, the joining system 40 may attempt to resume normal operations from a point where all operations were verified.

In some embodiments, the joining system 40 may comprise a joining machine 42 (e.g., a welding machine), a vision system 44, and a controller 46 in communication with the joining machine 42 and/or the vision system 44. It should be appreciated that the vision system 44 and/or the controller 46 may be directly coupled to the joining machine 42 or may be located remotely from the joining machine 42 while remaining in communication therewith. It is also understood that the joining system 40 may comprise more or less components than shown. In some instances, the controller 46 may include a human-machine interface to improve interactions with the operator. The joining machine 42 may include a base 47 having a robotic arm 48 and/or a feeder 49 for the articles 12, 12′. For example, the feeder 49 may be a vibratory bowl feeder. The base 47 of the joining machine 42 may be configured to be fixedly secured to a mounting structure (e.g., the floor 34). It is understood that the joining machine 42 may be anchored to the mounting structure by any suitable method such as by mechanical fasteners, for example.

In certain embodiments, the joining system 40 may be a welding system (e.g., a laser beam or torch welding system). The joining system 40, and preferably the joining machine 42, may be configured to generate a highly concentrated thermal energy source 43, for example, a beam of light (i.e., a laser beam) or an ignited torch, which produces thermal energy. The thermal energy is used to raise a temperature of joining surfaces of the workpieces 50 and/or the articles 12, 12′ above a melting point thereof. The joining system 40, and preferably the thermal energy source 43 thereof, using the articles 12, 12′ of the present disclosure allows for narrow, deep welds and high welding rates. Because the thermal energy source 43 is focused on a small area, the joining processes 100, 200 require low-temperature input when compared to other joining processes, which also minimizes heat-induced thermal stress and distortion of the workpieces. It should be appreciated that the joining system 40 of the present disclosure can be used in conjunction with various other joining systems (e.g., an arc welding system) if desired.

The joining system 40 may be configured to join together workpieces 50 (e.g., battery cells and/or components thereof) to produce one or more battery assemblies 52. For example, the battery assemblies 52 may include, but are not limited to, various industrial battery assemblies and sizes specifically targeting high volume stock battery assemblies. It should be appreciated, however, that the articles 12, 12′, the joining system 40, and the joining processes 100, 200 of the present disclosure are not specifically limited to production of the battery assembly 52 as described herein. The articles 12, 12′, the joining system 40, and the joining processes 100, 200 may be employed in various other applications (e.g., industrial, automotive, commercial, residential, etc.).

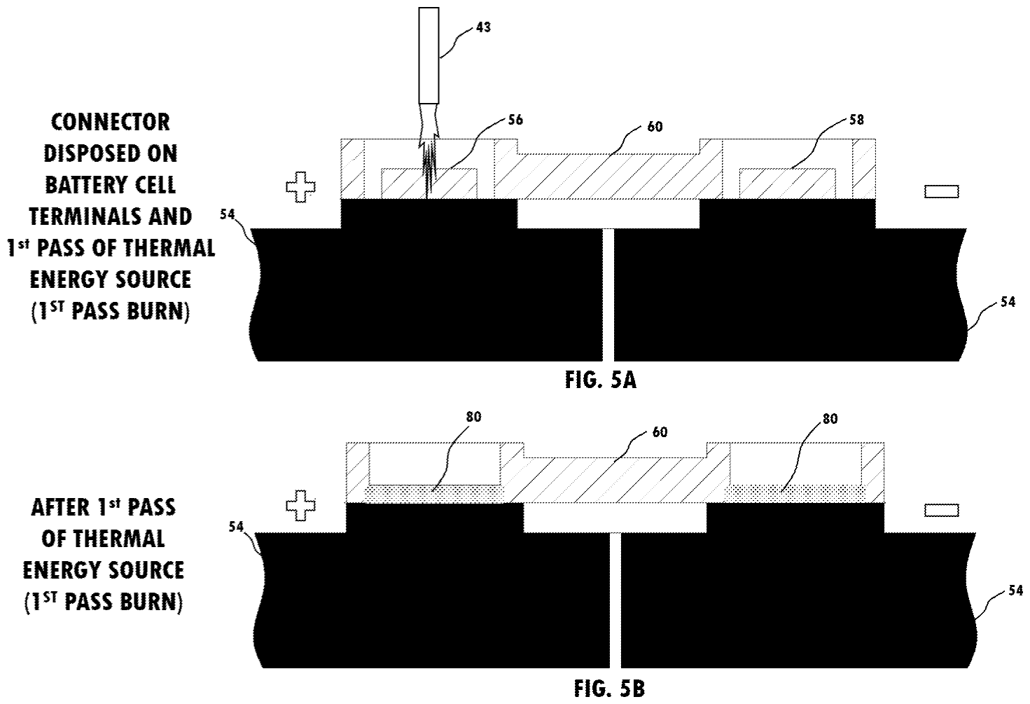

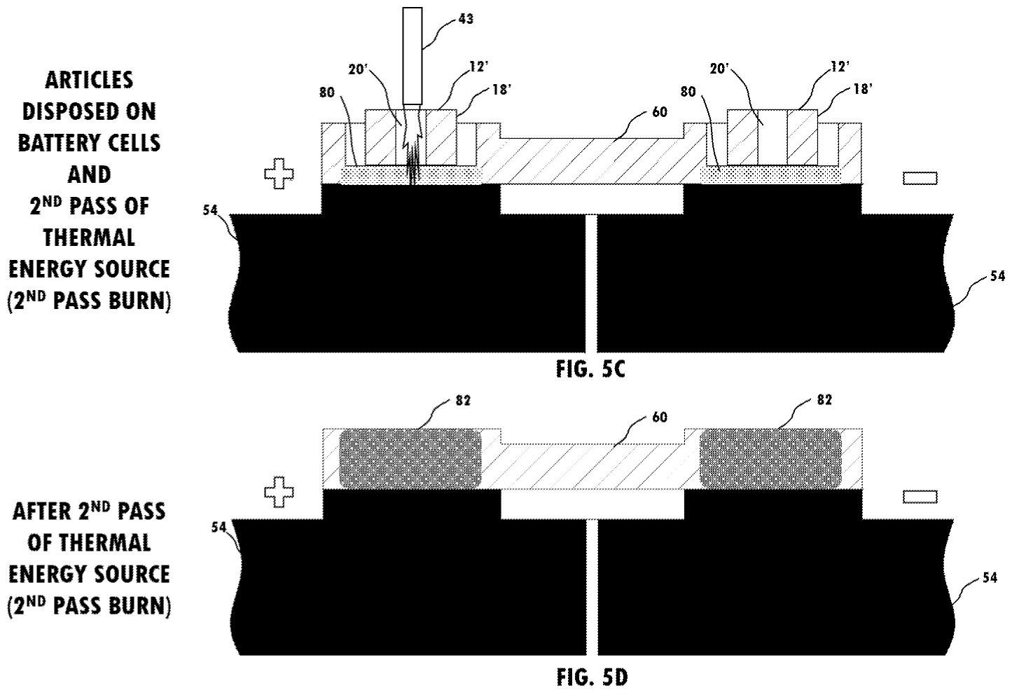

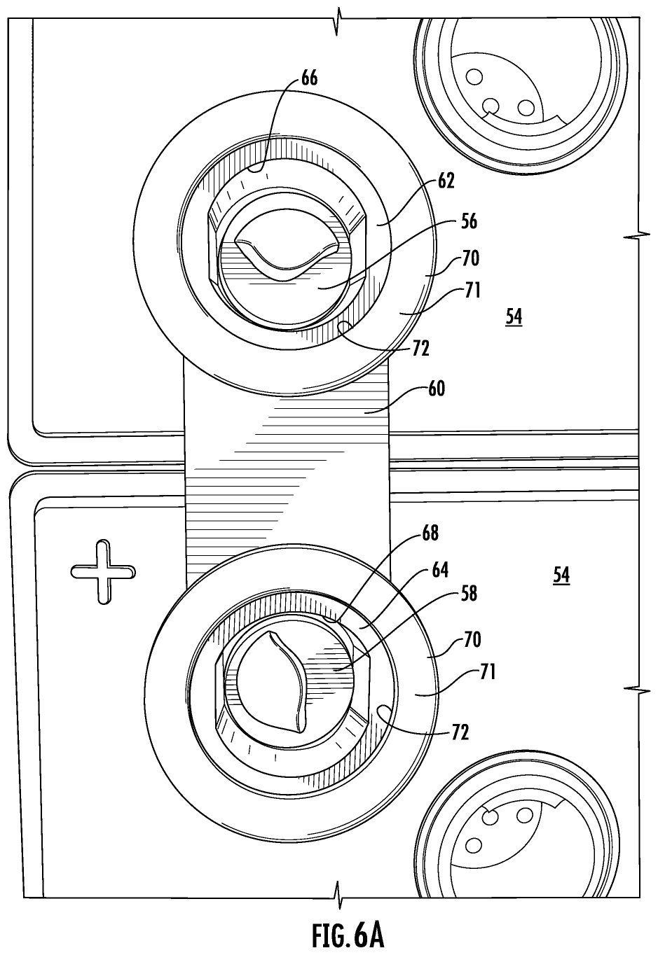

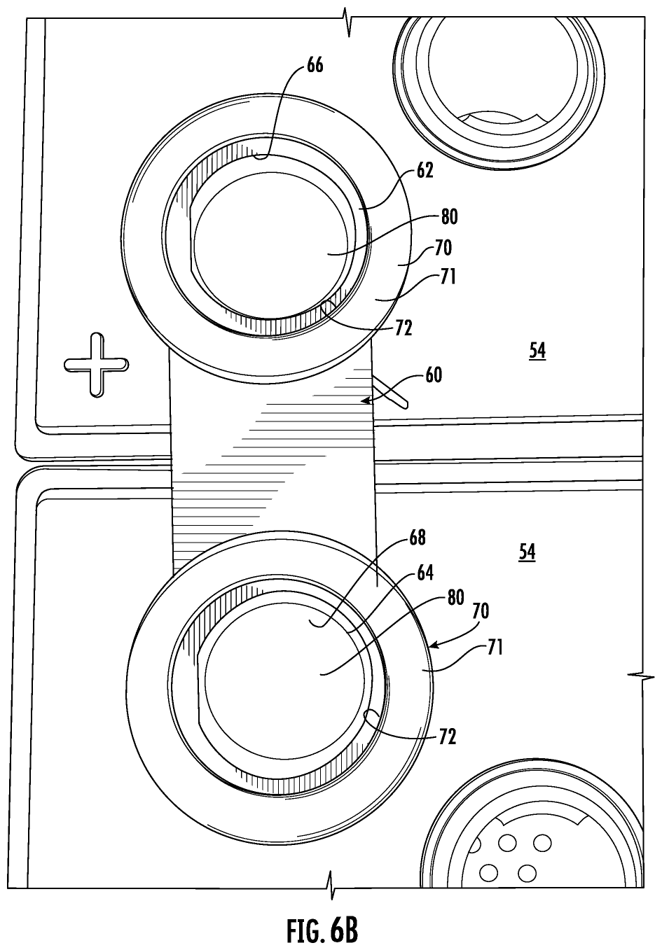

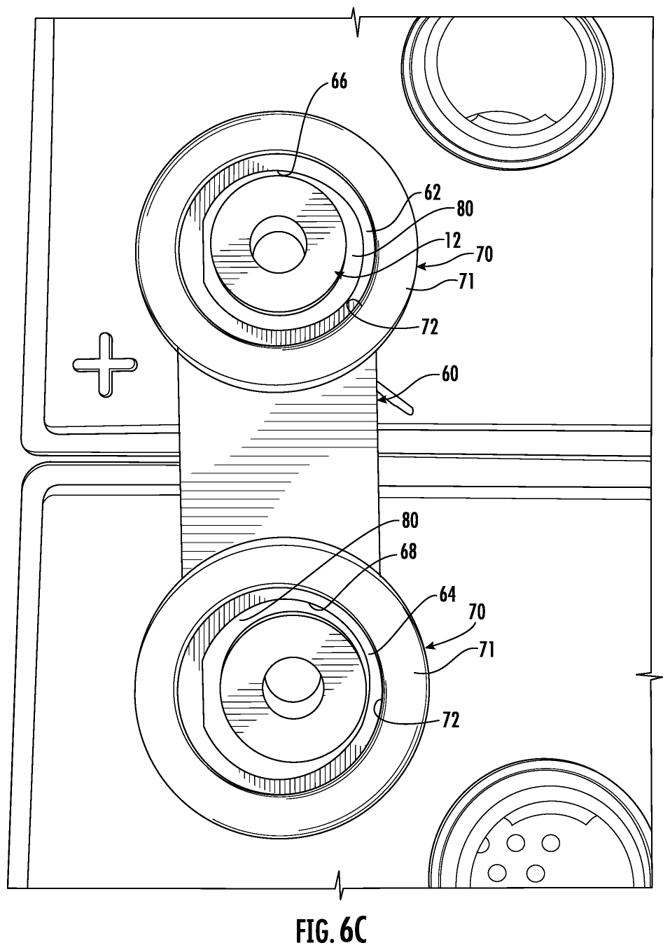

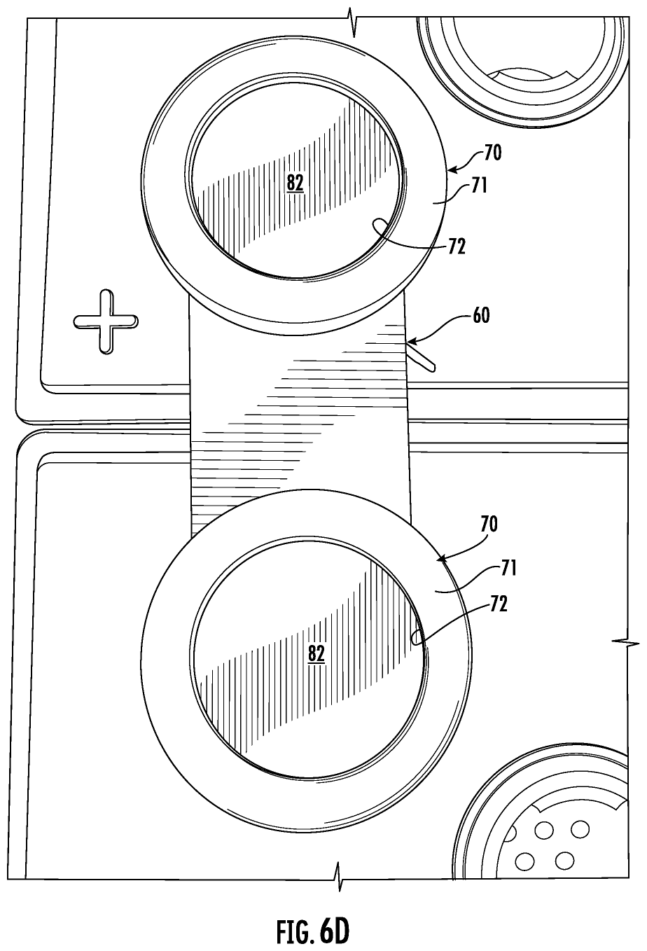

The battery assembly 52 may include a plurality of battery cells 54. Although each of the battery cells 54 shown has a generally rectangular shape, it is understood that the battery cells 54 may have any shape, size, and configuration as desired. It is further understood that the battery cells 54 may be rechargeable. Each of the battery cells 54 includes positive and negative electrode terminals 56, 58. The positive and negative electrode terminals 56, 58 each include a protruding portion and a joining surface provided around the protruding portion. The protruding portions of the positive and negative electrode terminals 56, 58 may be located in a middle of the joining surfaces thereof. As best seen in FIGS. 5A-5D and 6A-6D, adjacent battery cells 54 may be held together by one or more connectors 60 (i.e., an intercell connector, a strap, a busbar, a plate, a cable, etc.) to form the battery assembly 52. The connectors 60 may also militate against undesired separation of the battery cells 54 during storage and transport. In certain embodiments, the positive and negative electrode terminals 56, 58 of adjacent battery cells 54 are arranged to be linked together by the connectors 60 and the weld 82. Opposing ends 62, 64 of the connector 60 may be connected to a corresponding one of the positive and negative electrode terminals 56, 58. The battery cells 54 may be connected in series or parallel. In some embodiments, the ends 62, 64 of the connector 60 are provided with respective openings 66, 68 into which the protruding portion of one of the positive and negative electrode terminals 56, 58 is to be received. A space may be provided between an inner edge of the openings 66, 68 and the protruding portions of the positive and negative electrode terminals 56, 58 to expose the joining surfaces thereof. The space may also be configured to receive the articles 12, 12′ therein prior to a joining process 100, 200.

In some embodiments, one or more retainers 70 may be removably disposed on one of more ends 62, 64 of the connector 60 prior to the joining process 100, 200. Particularly, the retainer 70 may be a ring-shaped member 71 having a bore 72 configured to receive one of the end 52, 54 therein. As illustrated, the retainers 70 surround the ends 62, 64 and the protruding portions of the positive and negative electrode terminals 56, 58 to militate against a leakage of molten material onto the battery cells 54 during the joining process 62, 64. It is understood that the retainers 70 may be produced from any suitable material having a relatively high melting point and/or a melting point higher than a melting point of the articles 12, 12′ and the protruding portions of the positive and negative electrode terminals 56, 58 such as steel, for example.

FIG. 7 is a flow diagram representing a method or joining process 100 that may be employed by various joining systems, preferably the joining system 40 of FIGS. 3-4, using the articles 12, 12′ of FIGS. 1 and 2 in accordance with an embodiment of the present disclosure. At step 102, the operator engages an access request control on the controller 46 of the workstation 30. When the access request control is engaged, the robotic arm 48 of the joining machine 42 is moved/maintained in a home position at step 104, via the controller 46, to ensure that the workstation 30 is safe for entry. Thereafter, at step 106, the access door of the enclosure 32 is released and opened by the operator. The operator, at step 108, loads a plurality of the battery cells 54 of a battery assembly 52 through the access door of the workstation 30 into the joining machine 42 of the joining system 40. It is understood that a material handing device (e.g., a hand cart, a pallet jack, or a forklift) may be used by the operator to load the battery cells 54 into the joining machine 42. It should be appreciated that prior to loading the battery cells 54 into the joining machine 42, the battery cells 54 may include the connectors 60 and/or the retainer 70 disposed thereon, as shown in FIGS. 5A and 6A. At step 110, the operator then exists the workstation 30 and closes the access door of the enclosure 32. The joining system 40 at step 112, via the controller 46, then verifies that all access points are closed. In some embodiments, at step 114, the operator may select a type of the battery assembly 52 on the controller 46 and start operation of the joining system 40. In other embodiments, a selection of the type of battery assembly 52 is not needed, and the operator may initiate operation of the joining system 40 without. Prior to or substantially simultaneously with the start of operation of the joining system 40, the operator loads the articles 12, 12′ into the feeder of the joining machine 42. The joining system 40, via the controller 46, ensures all access points are closed and it is safe for the operation of the joining system 40 to proceed. One or more optical sensors 45 (e.g., a birdseye camera) of the vision system 44 at step 116, via the controller 46, captures a first image to locate initial locations of the positive and negative electrode terminals 56, 58, the connectors 60, and/or the retainers 70. At step 118, the robotic arm 48, via the controller 46, moves a depth laser above a location of one or more connectors 60 to measure and/or define a depth of the joining surfaces of the protruding portions of the positive and negative electrode terminals 56, 58. The joining machine 42 at step 120, via the controller 46, adjusts calibration to the type of battery assembly 52 and measured depth. At step 122, the robot arm 48, via the controller 46, then moves one or more of the optical sensors 45 overtop each initial location of the connectors 60 and captures a second image, essentially a “close-up” refinement of the locations of the joining surfaces of the protruding portions of the positive and negative electrode terminals 56, 58, the connectors 60, and/or the retainers 70. Based upon the first and second images captured by the one or more optical sensors 45, the joining system 40, at step 124, determines and/or verifies an optimal joining location and may commence further operations. Further, at step 124, the joining machine 42, via the controller 46, defines an exact location of each connector 60 and/or center point of the positive and negative electrode terminals 56, 58. The robotic arm 48 of the joining machine 42, via the controller 46, then uses the thermal energy source 43, for example the laser beam or the ignited torch, at step 126, to perform a first pass of the thermal energy source 43 (i.e., burn or weld) between the joining surfaces of the protruding portions of the positive and negative electrode terminals 56, 58 and the connectors 60 to form a material layer 80. As the first pass of the thermal energy source 43 is performed in certain embodiments, the thermal energy produced by the thermal energy source 43 is directed to and/or primarily focused on the protruding portions of the positive and negative electrode terminals 56, 58. It is understood, however, that the thermal energy source 43 may be directed as other portions of the positive and negative electrode terminals 56, 58 if desired. As such, the thermal energy is advantageously applied to the positive and negative electrode terminals 56, 58 and the positive and negative electrode terminals 56, 58, at least partially, transition to a molten state. Simultaneously, a portion of the connectors 60 are slowing absorbing thermal energy from the thermal energy source 43 and are also transitioning into a molten state and integrally combine with the molten portion of the positive and negative electrode terminals 56, 58 to form the material layer 80.

Once the first pass of the thermal energy source 43 is completed, as shown in FIGS. 5B and 6B, the robotic arm 48 of the joining machine 42, via the controller 46, returns to the home position. In some embodiments, the operator, at step 128, engages the access request control on the controller 46 of the workstation 30. As a result at step 130, the controller 46 may grant access and allow the operator to obtain one or more of the articles 12, 12′ of FIGS. 1 and 2 and place at least one of the articles 12, 12′ into each space formed by the openings 66, 68 of the connectors 60 and the joining surfaces of the material layer 80, as shown in FIGS. 5C and 6C. The operator then closes the access door of the enclosure 32 of the workstation 30 at step 132. In other embodiments, the robotic arm 48, via the controller 46, may be configured to obtain one or more of the articles 12, 12′ of FIGS. 1 and 2 and place at least one of the articles 12, 12′ into each space formed by the openings 66, 68 of the connectors 60 and the joining surfaces of the material layer 80. In some embodiments, one or more of the optical sensors 45 at step 134, via the controller 60, may check for a presence of the articles 12, 12′ prior to commencing further joining operations. The robotic arm 48 of the joining machine 42, via the controller 60, then uses the thermal energy source 43, for example the laser beam or the ignited torch, at step 136, to perform a second pass of the thermal energy source 43 (i.e., burn or weld) on all of the articles 12, 12′ and the joining surfaces. As the second pass of the thermal energy source 43 is performed, the thermal energy produced by the thermal energy source 43 is directed to and/or primarily focused on the center of the articles 12, or the bore 20′ of the articles 12′. In a preferred embodiment, the bore 20′ is critical because it permits an interior of the main body 18′ and/or the material layer 80 to be exposed to the thermal energy source 43, resulting in an optimized joining of the battery cells 54 and the connectors 60. It is understood, however, that the thermal energy source 43 may be directed as other portions (e.g., an off-center portion) of the articles 12, 12′ if desired. As such, the thermal energy is advantageously applied to the material layer 80 and, at least partially, return to a molten state. Simultaneously, the articles 12, 12′ are slowing absorbing thermal energy from the thermal energy source 43 and are also transitioning into a molten state to form a substantially homogenous weld 82 comprising an integral combining or joining of the material layer 80, the articles 12, 12′, and/or the connectors 60. As such, portions of the battery cells 54, the articles 12, 12′, and the connectors 60 are integrally joined to couple the battery cells 54 in the battery assembly 52. In some instances, the retainers 70 used by the vision system 44 to identify the optimal joining locations may also perform as a mold for the weld 82 to maintain a shape thereof throughout the joining process as well as militate against a leakage of the molten material of the material layer 80 and/or the articles 12, 12′ onto the battery cells 54.

In certain embodiments, upon completion of the second pass of the thermal energy source 43 as shown in FIGS. 5D and 6D, one or more of the optical sensors 45 at step 138, via the controller 46, may capture at least one image of the battery assembly 52 post joining operations for quality verification and other purposes. Particularly, the one or more optical sensors 45 may capture at least one image of the weld 82. It is understood, however, that the joining system 40 may be without the vision system 44 and other various means of quality verification may be employed, if desired. The robotic arm 48 of the joining machine 42, via the controller 46, then returns to the home position and the joining system 40 signals, via the controller 48, that the joining process 100 has been completed. The operator, at step 140, then engages the access request control on the controller 46 of the workstation 30 and the controller 46 may grant access thereto. The operator then removes the completed battery assembly 52 from the workstation 30.

FIG. 8 is a flow diagram representing a method or joining process 200 that may be employed by various joining systems, preferably the joining system 40 of FIGS. 3-4, using the articles 12, 12′ of FIGS. 1 and 2 in accordance with an embodiment of the present disclosure. At step 202, the operator loads a plurality of the battery cells 54 of a battery assembly 52 through the light curtain of the workstation 30 into the joining machine 42 of the joining system 40. It is understood that a material handing device (e.g., a hand cart, a pallet jack, or a forklift) may be used by the operator to load the battery cells into the joining machine 42. It should be appreciated that prior to loading the battery cells 54 into the joining machine 42, the battery cells 54 may include the connectors 60 and/or the retainer 70 disposed thereon, as shown in FIGS. 5A and 6A. In some embodiments, the operator, at step 204, may select a type of the battery assembly 52 on the controller 46 and start operation of the joining system 40. In other embodiments, a selection of the type of battery assembly 52 is not needed, and the operator may initiate operation of the joining system 40 without. Prior to or substantially simultaneously with the start of operation of the joining system 40, at step 206, the operator loads the articles 12, 12′ into the feeder of the joining machine 42. The joining system 40, at step 208, via the controller 46, ensures all access points are closed and it is safe for the operation of the joining system 40 to proceed. One or more optical sensors 45 (e.g., a birdseye camera) of the vision system 44 at step 210, via the controller 46, captures a first image to locate initial locations of the positive and negative electrode terminals 56, 58, the connectors 60, and/or locations of the retainers 70. The robotic arm 48 at step 212, via the controller 46, moves a depth laser above one or more locations of the connectors 60 to measure and/or define a depth of the joining surfaces of the protruding portions of the positive and negative electrode terminals 56, 58. The joining machine 42 at step 214, via the controller 46, adjusts calibration to the type of battery assembly 52 and measured depth. At step 216, the robot arm 48, via the controller 46, then moves one or more of the optical sensors 45 overtop each initial location of the connectors 60 and, via the controller 46, captures a second image, essentially a “close-up” refinement of the locations of the joining surfaces of the protruding portions of the positive and negative electrode terminals 56, 58, the connectors 60, and/or the retainers 70. Based upon the first and second images captured by the one or more optical sensors 45, the joining system 40 determines and/or verifies an optimal joining location and may commence further operations. Thereafter, the joining machine at step 218, via the controller 46, defines an exact location of each connector 60 and/or center point the positive and negative electrode terminals 56, 58. At step 220, the robotic arm 48 of the joining machine 42, via the controller 60, then uses the thermal energy source 43, for example the laser beam or the ignited torch, to perform a first pass of the thermal energy source 43 (i.e., burn or weld) between the joining surfaces of the protruding portions of the positive and negative electrode terminals 56, 58 and the connectors 60 to form the material layer 80. As the first pass of the thermal energy source 43 is performed in certain embodiments, the thermal energy produced by the thermal energy source 43 is directed to and/or primarily focused on the protruding portions of the positive and negative electrode terminals 56, 58. It is understood, however, that the thermal energy source 43 may be directed as other portions of the positive and negative electrode terminals 56, 58 if desired. As such, the thermal energy is advantageously applied to the positive and negative electrode terminals 56, 58 and the positive and negative electrode terminals 56, 58, at least partially, transition to a molten state. Simultaneously, a portion of the connectors 60 are slowing absorbing thermal energy from the thermal energy source 43 and are also transitioning into a molten state and integrally combine with the molten portion of the positive and negative electrode terminals 56, 58 to form the material layer 80.

Once the first pass of the thermal energy source 43 is completed, as shown in FIGS. 5B and 6B, the robotic arm 48 of the joining machine 42, via the controller 46, returns to a home position. The robotic arm 42 at step 222, via the controller 46, then obtains one or more of the articles 12, 12′ of FIGS. 1 and 2 and places at least one of the articles 12, 12′ into each space formed by the openings 66, 68 of the connectors 60 and the joining surfaces of the material layer 80, as shown in FIGS. 5C and 6C. In some embodiments, at step 224, one or more of the optical sensors 45, via the controller 46, may check for a presence of the articles 12, 12′ prior to commencing further joining operations. At step 226, the robotic arm 48 of the joining machine 42, via the controller 46, then uses the thermal energy source 43, for example the laser beam or the ignited torch, to perform a second pass of the thermal energy source 43 (i.e., burn or weld) on all of the articles 12, 12′ and the joining surfaces. As the second pass of the thermal energy source 43 is performed, the thermal energy produced by the thermal energy source 43 is directed to and/or primarily focused on the center of the articles 12, or the bore 20′ of the articles 12′. It is understood, however, that the thermal energy source 43 may be directed as other portions (e.g., an off-center portion) of the articles 12, 12′ if desired. In a preferred embodiment, the bore 20′ is critical because it permits an interior of the main body 18′ and/or the material layer 80 to be exposed to the thermal energy source 43, resulting in an optimized joining of the battery cells 54 and the connectors 60. As such, the thermal energy is advantageously applied to the material layer 80 and, at least partially, return to a molten state. Simultaneously, the articles 12, 12′ are slowing absorbing thermal energy from the thermal energy source 43 and are also transitioning into a molten state to form a substantially homogenous weld 82 comprising an integral combining or joining of the material layer 80, the articles 12, 12′, and/or the connectors 60. As such, portions of the battery cells 54, the articles 12, 12′, and the connectors 60 are integrally joined to couple the battery cells 54 in the battery assembly 52. In some instances, the retainers 70 used by the vision system 44 to identify the optimal joining locations may also perform as a mold for the weld to maintain a shape thereof throughout the joining process as well as militate against a leakage of the molten material of the material layer 80 and/or the articles 12, 12′ onto the battery cells 54

In certain embodiments, upon completion of the second pass of the thermal energy source 43, as shown in FIGS. 5D and 6D, at step 228, one or more of the optical sensors 45, via the controller 46, may capture at least one image of the battery assembly 52 post joining operations for quality verification and other purposes. Particularly, the one or more optical sensors 45 may capture at least one image of the weld 82. It is understood, however, that the joining system 40 may be without the vision system 44 and other various means of quality verification may be employed, if desired. At step 230, the robotic arm 48 of the joining machine 42, via the controller 46, then returns to the home position and the joining system 40 signals, via the controller 46, that the joining process has been completed. The operator, at step 232, then removes the completed battery assembly 52 from the workstation 30.

Advantageously, the articles 12, 12′, system, and method of the present disclosure eliminates the need to have an operator manually join the battery cells 54 of the battery assembly 52. By automating the joining processes 100, 200, a quality of the battery assembly 52 and operator safety are improved, while minimizing cost thereof and exposure of the operator to undesirable and/or harmful fumes and particulates emitted during the joining processes 100, 200.

Although the exemplary joining processes 100, 200 described herein include a manual loading and unloading of the workpieces 50 (e.g., the battery cells 54 of the battery assembly 52) into the workstation 30, it should be appreciated that the loading and unloading steps 108, 140, 202, 232 as well as other manual steps of the joining processes 100, 200 may be automated or semi-automated. For example, a conveyor or assembly line may be utilized to load and unload the joining system 40. It should also be appreciated that the workstation 30 and/or the joining system 40 may be part of a larger manufacturing line, if desired.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. An article used in a joining process for a battery assembly, comprising:
a main body configured to be cooperate with a connector for a battery assembly; and
a bore formed in the main body, wherein the bore permits exposure of at least one joining surface of the battery assembly to a thermal energy source.

2. The article of claim 1, wherein the main body includes generally planar opposing axial surfaces and a substantially smooth peripheral surface.

3. The article of claim 1, wherein the bore is formed through an entirety of the main body.

4. The article of claim 1, wherein the main body is one of a solid disk shape and a ring shape.

5. The article of claim 1, wherein the article is produced from at least one of a lead material and a lead alloy material.

6. A system for a battery cell joining process, comprising:
a joining machine including a thermal energy source, wherein joining machine uses at least one article to couple together a plurality of battery cells to form a battery assembly, wherein the at least one article comprises a main body configured to permit exposure of at least one joining surface of at least one of the battery cells to the thermal energy source.

7. The system of claim 6, wherein the at least one article is disposed in at least one opening of a connector of the battery assembly.

8. The system of claim 6, further comprising a controller in communication with the joining machine, wherein the controller is configured to control an operation of the joining machine.

9. The system of claim 6, further comprising a vision system, wherein the vision system captures at least one image of the at least one joining surface of the battery cell.

10. The system of claim 9, wherein the vision system is in communication with the controller to define an exact location of positive and negative electrode terminals of the battery cells.

11. A joining process, comprising:
providing a joining system including a joining machine configured to use one or more articles to couple together a plurality of workpieces;
loading the workpieces into the joining system;
disposing the one or more articles on the workpieces; and
coupling the workpieces together by causing the one or more articles and a portion of the workpieces to be integrally joined.

12. The joining process of claim 11, wherein the workpieces are battery cells.

13. The joining process of claim 11, further comprising disposing at least one connector on adjacent workpieces prior to disposing the one or more articles on the workpieces.

14. The joining process of claim 13, further comprising disposing at least one retainer on the at least one connector to militate against leakage of a molten material.

15. The joining process of claim 13, further comprising causing a first pass of a thermal energy source to cause a portion of the workpieces and the at least one connector to be integrally joined.

16. The joining process of claim 15, wherein the step of disposing the one or more articles on the workpieces occurs after the first pass of the thermal energy source.

17. The joining process of claim 15, wherein the step of coupling the workpieces together by causing the one or more articles and a portion of the workpieces to be integrally joined is achieved during a second pass of the thermal energy source.

18. The joining process of claim 13, wherein the joining system further includes a vision system to locate at least one position of at least one of the workpieces, the at least one connector, and the at least one article.

19. The joining process of claim 18, wherein the vision system captures one or more images to locate joining surfaces of the workpieces.

20. The joining process of claim 13, wherein the joining system further includes a controller in communication with the joining machine, wherein the joining machine, via the controller, moves a depth laser above one or more locations of the connectors to measure and/or define a depth of joining surfaces of the workpieces.
